(19) United States
(12) Patent Application Publication
(10) Pub. No.: US 2026/0021506 A1
(43) Pub. Date: Jan. 22, 2026

(54) UNITARY SPRAY NOZZLE

(71) Applicant: Road Erase LLC, Boca Raton, FL (US)

(72) Inventors: Frank J. Landi, JR., Delray Beach, FL (US); Wayne R. Fugate, Summerfield, FL (US); John E. Miller, Boynton Beach, FL (US); Michael Peter Hutton, Parkland, FL (US)

(73) Assignee: Road Erase LLC, Boca Raton, FL (US)

(21) Appl. No.: 18/779,235

(22) Filed: Jul. 22, 2024

(51) Int. Cl. B05B 15/63; B05B 1/04; B05B 1/14; B05B 1/30; B05B 15/65

(52) U.S. Cl. CPC B05B 15/63; B05B 1/044; B05B 1/14; B05B 1/302; B05B 15/65

(57) ABSTRACT

The present invention is directed to a unitary single molded spray nozzle. The nozzle has a body extending from an entry to an exit with a hollow cavity. The entry includes threads for securing to a source of liquid. The exit includes a pair of nozzles with slotted orifices. A handle is secured to the outside of the body by a pair of diametrically opposed rods. The nozzle also includes a ball valve positioned within the body and secured to the pair of rods. The ball valve having a channel configured to open when the handle is in an opened configuration to permit a liquid to flow from the entry to the exit, and configured to close off the liquid when the handle is moved to a closed configuration.

### FIELD OF THE INVENTION

The present invention relates generally to a spray nozzle.

### BACKGROUND OF THE INVENTION

Spray nozzles and devices have long been in use. The nozzle are typically threaded or attached to a hose and used to create various sprays for washing. Most spray nozzles are made from a metal material that when used to close to the object being washed can cause scratching if inadvertent touching occurs. As such, there is a need for a spray nozzle that does not create the same disadvantages seen in past or current designs.

### SUMMARY OF THE INVENTION

This invention is directed to providing a unitary single molded spray nozzle. The nozzle includes a body extending from an entry end to an exit end. The body has a hollow cavity from the entry end to the exit end to create a continuous interior section. The entry end includes interior threads for securing to a source of liquid. An entry ring is positioned above the interior threads within the hollow cavity and extends towards the centerline of the interior section such that the entry ring is configured as a stop when threading a hose into the entry ring. The exit end includes a pair of slotted nozzles with exit points in fluid communication with the hollow cavity. The slotted nozzles are configured with narrowing nozzle exits to increase the pressure of the liquid as it is ejected. A handle is secured to the outside of the body. The handle has a pair of diametrically opposed rods extending into the body and secured to a ball valve positioned in the interior section of the body. The ball valve has a channel opening that aligns with the interior section when the handle is in an opened configuration, allowing the liquid to traverse the interior section from the entry end to the exit end, and when the handle is moved to a closed configuration the channel opening is moved to seal the interior section to prevent liquid from moving from the entry end to the exit end.

In another aspect of the embodiment, the body, handle, and ball valve are integrally molded from a semi-rigid material selected from the group consisting of plastic, polypropylene, and thermoplastic rubber.

### BRIEF DESCRIPTION OF THE DRAWINGS

A fuller understanding of the foregoing may be had by reference to the accompanying drawings, wherein:

FIG. 1 show a spray nozzle in accordance with an embodiment of the invention;

FIG. 2 shows the spray nozzle from FIG. 1 from an different perspective view;

FIG. 3 shows the spray nozzle from FIG. 1 from an different perspective view;

FIG. 4 shows the spray nozzle from FIG. 1 illustrating the entry end;

FIG. 5 shows the spray nozzle from FIG. 1 illustrating the exit end;

FIG. 6 illustrates the spray nozzle from a cross sectional view showing a ball valve in an open configuration;

FIG. 7 is another perspective view of FIG. 6;

FIG. 8 illustrates the spray nozzle from a cross sectional view showing a ball valve in a partially open configuration;

FIG. 9 illustrates the spray nozzle from a cross sectional view showing a ball valve in a closed configuration;

FIG. 10 illustrates the spray nozzle from a cross sectional view showing a ball valve in an closed configuration;

FIG. 11 illustrates the spray nozzle in accordance with another embodiment.

### DESCRIPTION OF THE EMBODIMENTS

While the invention is susceptible to embodiments in many different forms, there are shown in the drawings and will described herein, in detail, the preferred embodiments of the present invention. It should be understood, however, that the present disclosure is to be considered an exemplification of the principles of the invention and is not intended to limit the spirit or scope of the invention and the embodiments illustrated.

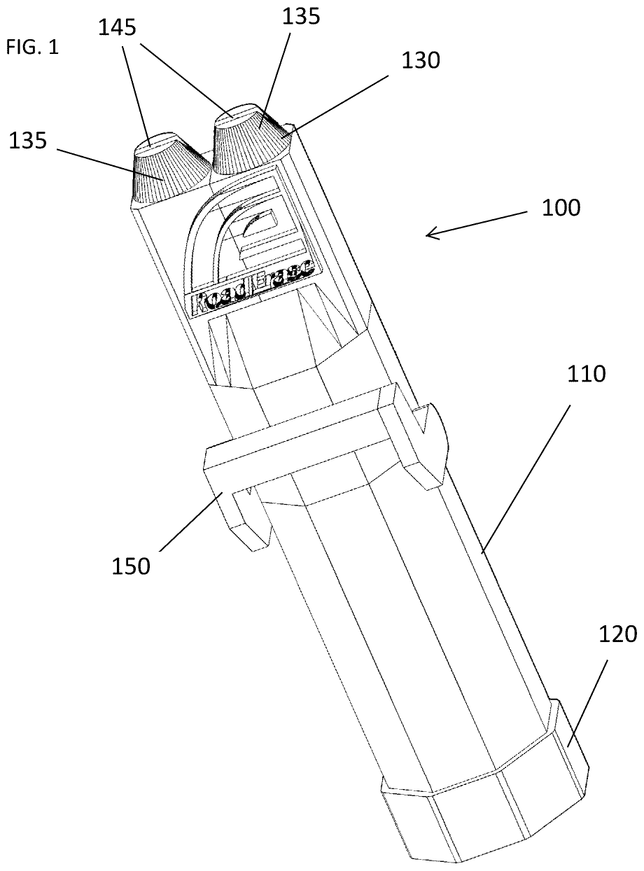

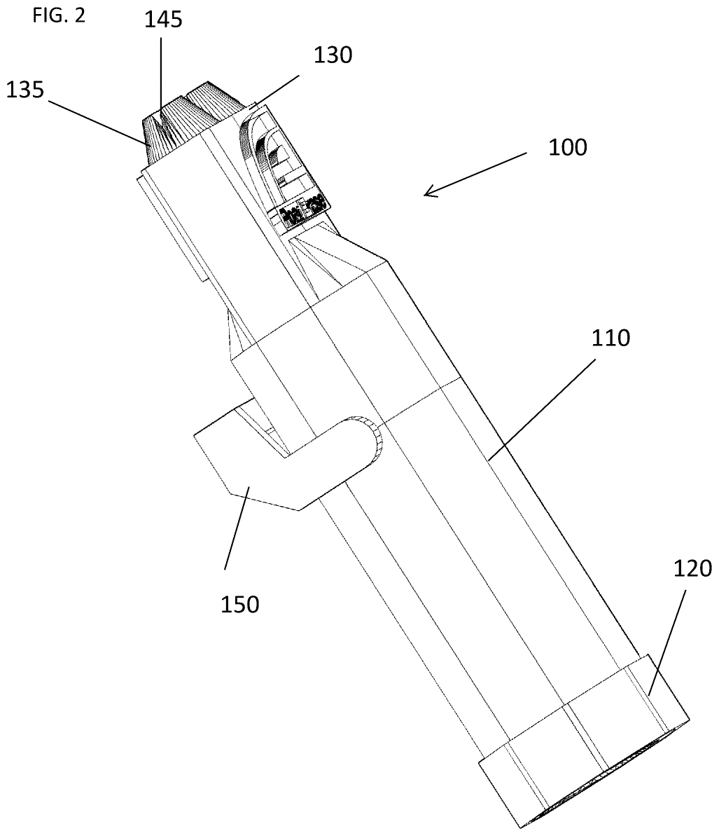

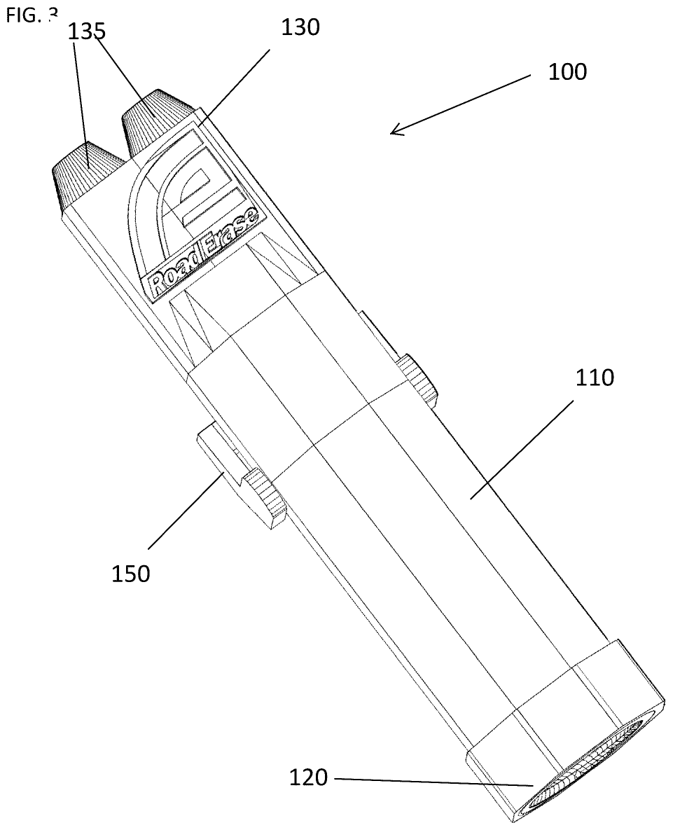

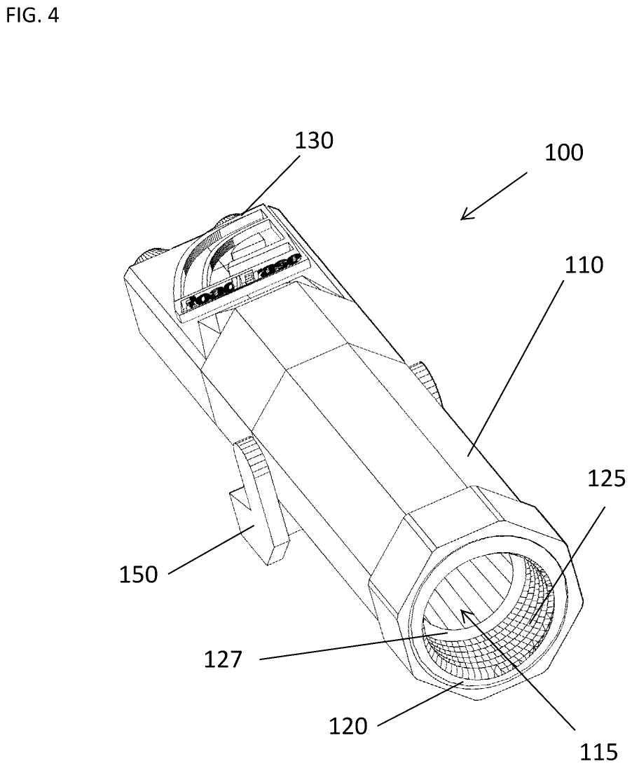

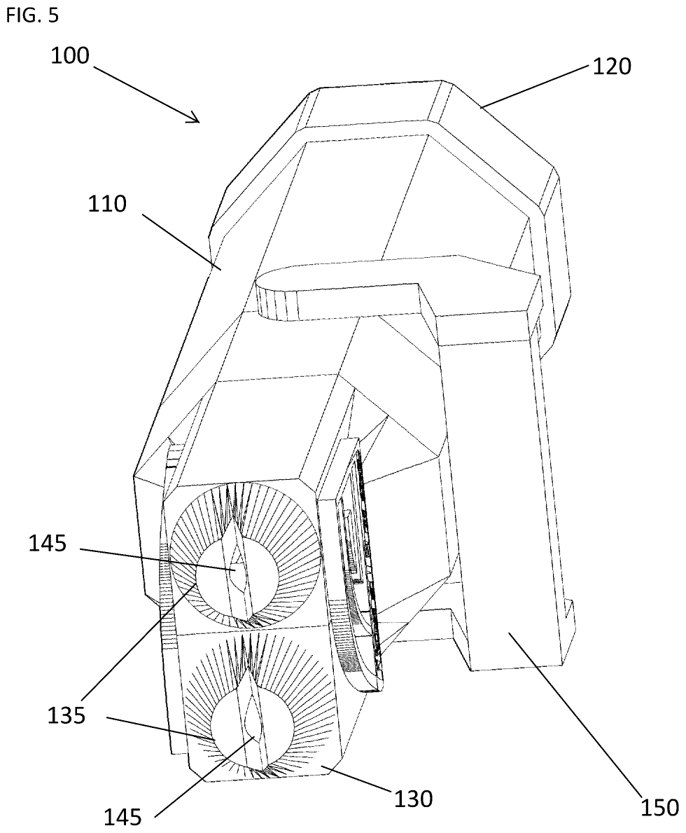

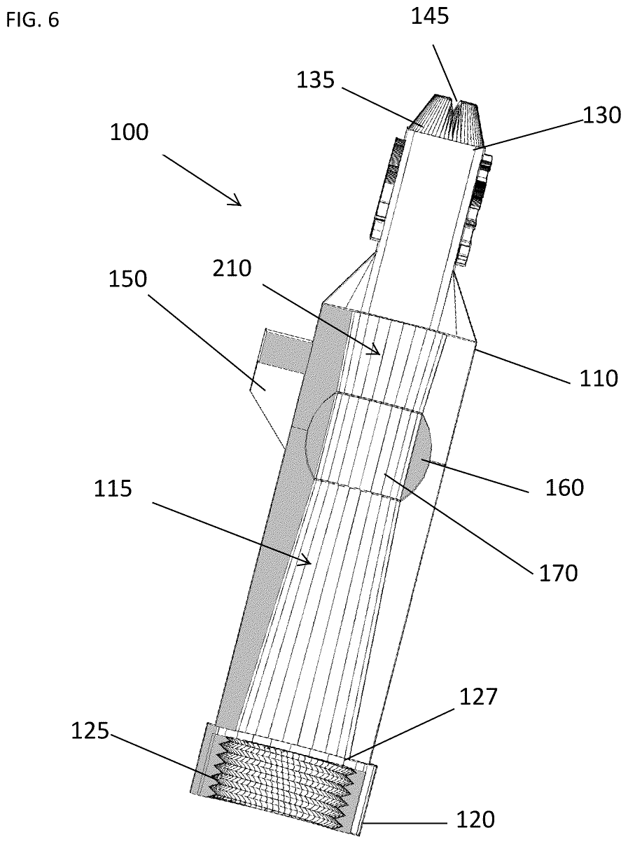

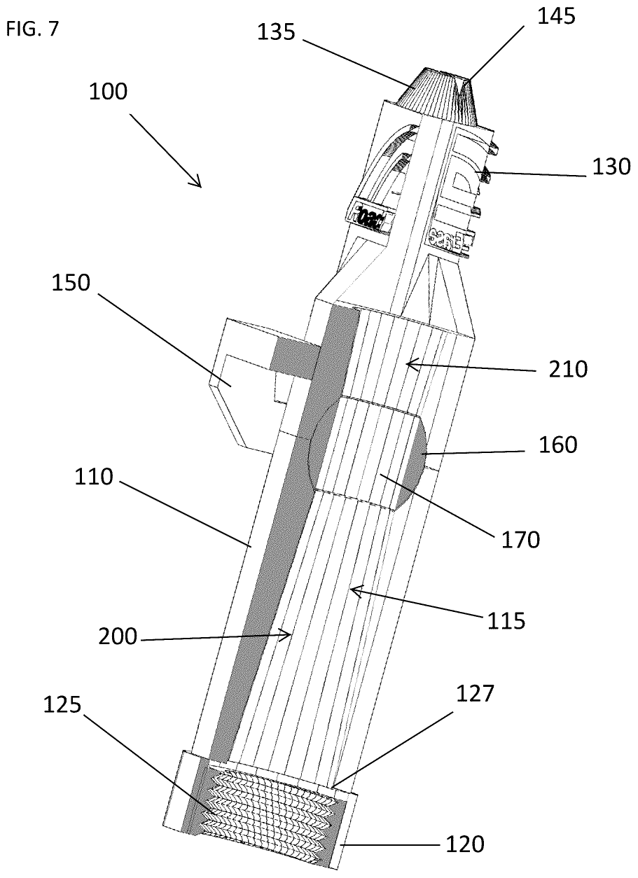

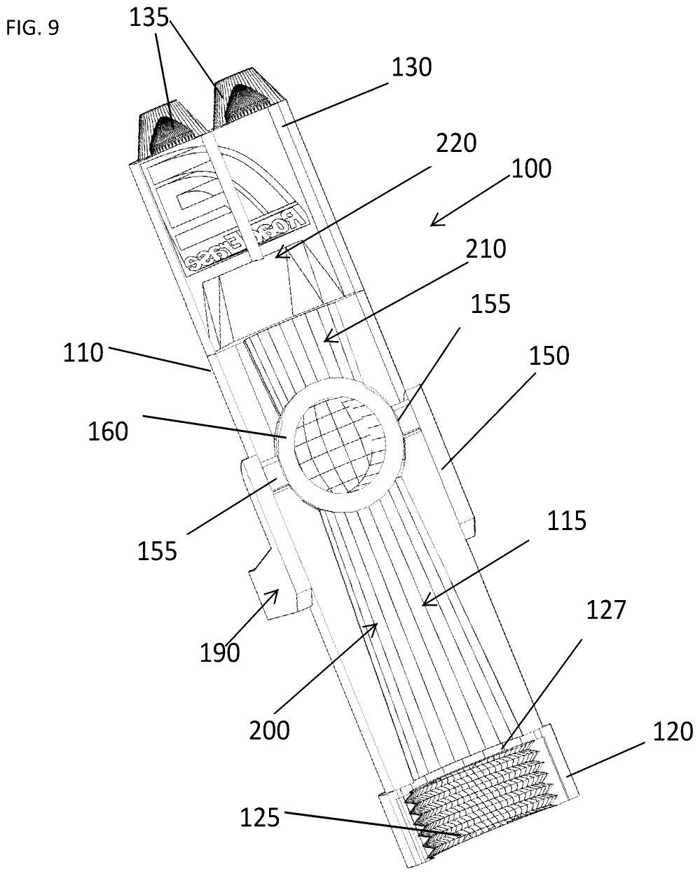

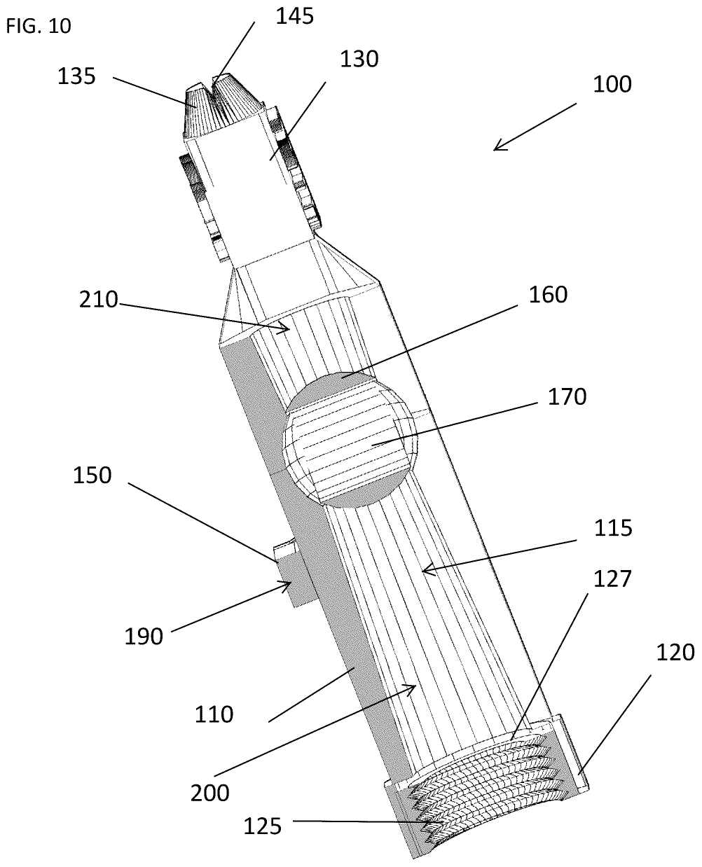

Referring to the drawings in greater detail, and first to FIGS. 1-10, the invention is embodied as a unitary single molded spray nozzle 100. The spray nozzle 100 has a body 110 that extends from a entry end 120 to an exit end 130. The body 110 is hollow creating an interior section 115.

The entry end 120 secures to a source of liquid, such as a hose or power spraying. The entry end 120 includes interior threads 125 that tightens against the end of the hose. In addition, the entry end 110 further includes a entry ring 127 positioned above the interior threads 120 and which the entry ring 127 extends towards the centerline of the interior section 115 defined within the body 110. The entry ring acts as a stop for the hose when threading into the entry end 120.

The exit end 130 includes a pair of slotted nozzles 135 that have exit points 140 to eject the liquid or water and which are in fluid communication with the interior section 115 of the body 110. The slotted nozzles 135 are configured with a narrowing slotted orifices 145 to increase the pressure of the liquid as it is ejected from the spray nozzle 100.

In addition, the spray nozzle 100 may include a handle 150 secured to the outside of the body 110. The handle 150 includes a pair of diametrically opposed rods 155 extending from the handle 150 through the body 110 and secured to a ball valve 160 positioned in the interior section 115 of the body 110. The ball valve 160 has a channel opening 170 through the ball valve that is aligned with the interior section 115 when the handle is in an opened configuration 180, which allows the liquid to traverse the interior section to the exit end 130. When the handle 150 is moved to a closed configuration 190, the channel opening 170 is moved such that the ball valve is closed to the interior section 115, which closes off the liquid from moving to the exit end 130.

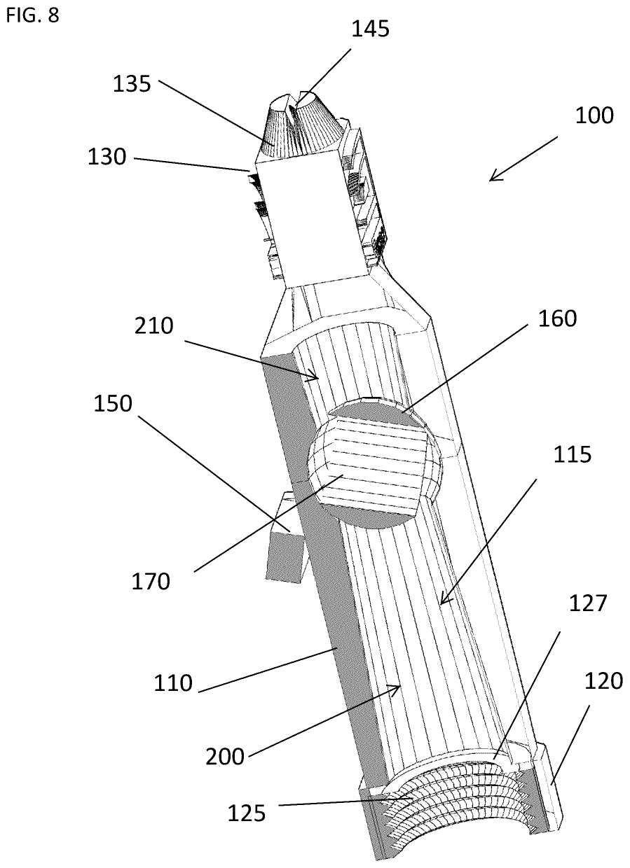

FIG. 8. Specifically shows the handle 150 in an intermediate position, such that the ball valve 150 and its channel opening 170 is not fully aligned nor fully closed off.

As illustrated in the Figures, the interior section 115 can be broken into sections, a first section 200 configured between the entry end and the ball valve, a second section 210 configured between the ball valve and the exit end, a third section 220 from the exit end to the slotted nozzles 135. In the first section 200 the interior section narrows towards the ball valve 160. The second section 210 then expands outwardly towards the third section 220. In the third section 220 the interior narrows to the exit end. The interior of the slotted nozzles 135 are further narrowed. All of which is configured to crate a spray or wall of water ejecting from the slotted nozzles 135.

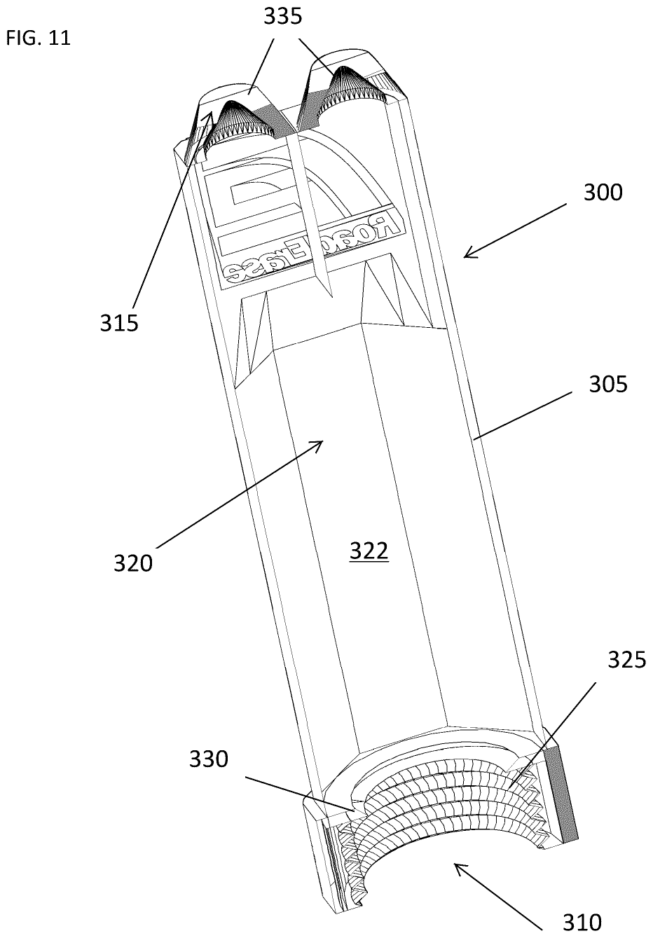

In another embodiment, FIG. 11 shows an unitary single molded spray nozzle 300. The nozzle includes a body 305 extending from an entry end 310 to an exit end 315. The body 305 has a hollow cavity 320 from the entry end to the exit end to create a continuous interior section 322. The entry end 310 including interior threads 325 for securing to a source of liquid. The entry end 310 has an entry ring 330 positioned above the interior threads, wherein the entry ring 330 extends towards the centerline of the interior section 322. The exit end 315 including a pair of nozzles 335 with slotted orifices. The nozzles 335 being in fluid communication with the interior section 322. The pair of nozzle 335 being tapered in a narrowing configuration towards the slotted orifices to increase the pressure of the liquid as it is ejected.

The entire structure, including the handle and ball valve, is a single molded unitarily fabricated of semi-rigid material, such as plastic or polypropylene or thermoplastic rubber. This prevents the use of metals which can scratch the surface of an object that is being sprayed. In addition, because the structure is plastic or polypropylene there is no need for gaskets.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A unitary single molded spray nozzle, comprising:
a body extending from an entry end to an exit end, said body having a hollow cavity from the entry end to the exit end to create a continuous interior section;
the entry end including interior threads for securing to a source of liquid, the entry end having an entry ring positioned above the interior threads, wherein the entry ring extends towards the centerline of the interior section;
the exit end including a pair of nozzles with slotted orifices, the nozzles being in fluid communication with the interior section, the pair of nozzle being tapered in a narrowing configuration towards the slotted orifices to increase the pressure of the liquid as it is ejected; and
a handle secured to the outside of the body, said handle including a pair of diametrically opposed rods attaching to the body.

2. The unitary single molded spray nozzle of claim 1, further comprising:
a ball valve positioned in the interior section of the body and secured to the pair of diametrically opposed rods that are attached to the handle, and the ball valve having a channel opening: (a) configured to align with the interior section when the handle is in an opened configuration, such that a liquid flowing into the entry end traverses the interior section through the channel opening of the ball valve to the exit end, and (b) configured to close off the liquid when the handle is moved to a closed configuration.

3. The unitary single molded spray nozzle of claim 2, wherein the body, handle, and ball valve are integrally molded from a semi-rigid material selected from the group consisting of plastic, polypropylene, and thermoplastic rubber.

4. The unitary single molded spray nozzle of claim 1, wherein the interior section is divided into a first section, a second section, and a third section, wherein:
the first section is configured between the entry end and the ball valve and narrows towards the ball valve;
the second section is configured between the ball valve and the exit end and expands outwardly towards the third section; and
the third section extends from the exit end to the slotted nozzles and narrows towards the exit end.

5. The unitary single molded spray nozzle of claim 1, wherein the handle is configured to move to an intermediate position such that the channel opening of the ball valve is neither fully aligned nor fully closed off, thereby reducing the flow of a liquid from the entry end to the exit end.

6. The unitary single molded spray nozzle of claim 1, wherein the ball valve is positioned in the interior section such that it divides the interior section into a entry section and a exit section.

7. The unitary single molded spray nozzle of claim 1, wherein the slotted nozzles are configured to create a spray or wall of liquid when ejected.

8. A unitary single molded spray nozzle, comprising:
a body extending from an entry end to an exit end, said body having a hollow cavity from the entry end to the exit end to create a continuous interior section;
the entry end including interior threads for securing to a source of liquid, the entry end having an entry ring positioned above the interior threads, wherein the entry ring extends towards the centerline of the interior section;
the exit end including a pair of nozzles with slotted orifices, the nozzles being in fluid communication with the interior section, the pair of nozzle being tapered in a narrowing configuration towards the slotted orifices to increase the pressure of the liquid as it is ejected;
a handle secured to the outside of the body, said handle including a pair of diametrically opposed rods attaching to the body; and
a ball valve positioned in the interior section of the body and secured to the pair of diametrically opposed rods that are attached to the handle, and the ball valve having a channel opening: (a) configured to align with the interior section when the handle is in an opened configuration, such that a liquid flowing into the entry end traverses the interior section through the channel opening of the ball valve to the exit end, and (b) configured to close off the liquid when the handle is moved to a closed configuration.

9. The unitary single molded spray nozzle of claim 8, wherein the body, handle, and ball valve are integrally molded from a semi-rigid material selected from the group consisting of plastic, polypropylene, and thermoplastic rubber.

10. The unitary single molded spray nozzle of claim 9, wherein the interior section is divided into a first section, a second section, and a third section, wherein:
the first section is configured between the entry end and the ball valve and narrows towards the ball valve;
the second section is configured between the ball valve and the exit end and expands outwardly towards the third section; and
the third section extends from the exit end to the slotted nozzles and narrows towards the exit end.

11. The unitary single molded spray nozzle of claim 10, wherein the handle is configured to move to an intermediate position such that the channel opening of the ball valve is neither fully aligned nor fully closed off, thereby reducing the flow of a liquid from the entry end to the exit end.

12. The unitary single molded spray nozzle of claim 8, wherein the slotted nozzles are configured to create a spray or wall of liquid when ejected.

13. A unitary single molded spray nozzle comprising:
a body extending from an entry to an exit with a hollow cavity;
the entry includes threads for securing to a source of liquid;
the exit includes a pair of nozzles with slotted orifices;
a handle is secured to the outside of the body by a pair of diametrically opposed rods;
a ball valve is positioned within the body and secured to the pair of rods, the ball valve having a channel configured to open when the handle is in an opened configuration to permit a liquid to flow from the entry to the exit, and configured to close off the liquid when the handle is moved to a closed configuration; and
wherein the body, handle, and ball valve are integrally molded from a single semi-rigid material selected from the group consisting of plastic, polypropylene, and thermoplastic rubber.
